(19) United States
(12) Patent Application Publication
(10) Pub. No.: US 2009/0147824 A1
(43) Pub. Date: Jun. 11, 2009

(54) Wireless remote passive temperature sensor for monitoring food

(75) Inventors: William Joseph Schafer, Rockville, MD (US); Matthew Price, Derwood, MD (US)

Correspondence Address: Bill Schafer, 309 Lorraine Drive, Rockville, MD, 20852, US

(73) Assignee: WT Systems, LLC, Rockville, MD (US)

(21) Appl. No.: 12/314,283

(22) Filed: Dec. 8, 2008

Related U.S. Application Data
(60) Provisional application No. 60/996,839, filed on Dec. 7, 2007.

(51) Int. Cl. G01K 7/34

(52) U.S. Cl. 374/183; 374/E07.037

(57) ABSTRACT

A passive wireless temperature sensor with a loop antenna is placed in a remote environment for exposure to its changing temperature conditions. The sensor includes a coil of wire wrapped around a cylinder to form an air-core inductor. The cylinder contains a small amount of eutectic material similar to a conventional thermometer which has the property of being magnetic. A capacitor is connected to the coil of wire to form a resonant LC “tank” circuit. As temperature increases, the eutectic material expands through the cylinder at the core of the inductor causing an increase in inductance and corresponding decrease in the resonant frequency of the LC “tank” circuit. The temperature of the remote sensor is proportional to resonant frequency and can be determined by generating an oscillating signal and measuring resonant frequency of the remote sensor.

### CROSS REFERENCE TO RELATED APPLICATIONS

This patent application claims benefit from Provisional Patent Application: “WIRELESS REMOTE PASSIVE TEMPERATURE SENSOR DEVICE FOR MONITORING FOOD” application No. 60/996,839 submitted Dec. 7, 2007.

### BACKGROUND OF THE INVENTION

The present invention generally relates to a device and system comprising a wireless temperature sensor and transceiver for the purposes of monitoring food while cooking, and more particularly is related to a novel wireless temperature sensor.

Cooking food to correct temperatures is critical to food safety and taste. Accurately monitoring food temperatures while cooking is important to ensure appropriate final temperature is achieved. Food cooking temperature monitoring systems are well known but the systems have not, as far as is known, employed passive wireless temperature sensors utilizing a resonant LC “tank” circuit. In particular, the present invention primarily is concerned with deriving information from remote positions and, also with the use of a wireless temperature sensor comprising an LC “tank” circuit for this purpose. For example, the present system is particularly concerned with monitoring temperature of food while cooking. Monitoring food temperatures remotely is desired so as to minimize constant observation. To accomplish this purpose, temperature probes connected to readers with wires and the like are inserted into food and placed in an oven, stove or on a grille. One problem, however, is that probes which are connected to readers through wires and the like limit the movement of food while cooking and are inconvenient to install and remove, especially when the temperature of multiple food objects are to be monitored.

The need for direct electrical coupling between the temperature sensor and the reader is avoided by the use of a device and system which comprises a ‘wireless’ temperature sensor and reader. As far as is known, such systems have not been successfully developed although the reasons for the absence of such development work can only be surmised. One problem however is that wireless temperature sensors which require semiconductor components that can operate at elevated temperatures such as required when cooking food are so expensive as to prohibit commercial viability.

### BRIEF SUMMARY OF THE INVENTION

A wireless temperature sensor device and system is described that is able to function at high temperatures such as present in an oven used for the purposes of cooking food, the device and system comprises a wireless temperature sensor and an inductively coupled reader.

Generally considered, the present invention involves transmitting a swept sinusoidal signal through a loop antenna that inductively couples to a remote wireless temperature sensor which in the preferred form is inserted in food. Other applications, of course, are contemplated. The wireless temperature sensor includes a coil of wire wrapped around a cylinder to form an air-core inductor. The cylinder contains a small amount of material such as Mercury or Galinstan similar to a conventional thermometer. A capacitor is connected to the coil of wire to form a resonant LC “tank” circuit. As is to be particularly noted, as temperature increases, the mercury expands through the core of the inductor causing an increase in inductance and corresponding decrease in the resonant frequency of the LC “tank” circuit. The resonant frequency is thus proportional to temperature. A loop antenna that inductively couples to the remote sensor can be located remotely from the sensor. The present invention does not require semiconductor components and is able to operate at elevated temperatures for prolonged periods.

A single reader can detect the temperature of multiple remote sensors by using different tuning capacitors and inductance values in the LC “tank” circuit of each sensor, therefore a given remote sensor will resonate over specific unique frequency ranges that can be distinguished by the reader. Each passive temperature probe is designed to operate over a specific range of frequencies.

One object of the invention is to provide a ‘wireless’ temperature sensor system for measuring food temperature remotely.

Another object is to provide temperature sensing devices based on resonant frequency change principles.

A further object is to provide a remote temperature monitoring system especially adapted for monitoring temperature of food during cooking.

Other systems, methods, features, and advantages of the present invention will be or become apparent to one with the skill in the art upon examination of the following drawings and detailed description. It is intended that all such additional systems, methods, features, and advantages be included within this description, be within the scope of the present invention, and be protected by the accompanying claims.

### BRIEF DESCRIPTION OF THE SEVERAL VIEWS OF THE DRAWING

Many aspects of the invention can be better understood with reference to the following drawings. The components in the drawing are not necessarily to scale, emphasis instead being placed upon clearly illustrating the principles of the present invention. Moreover, in the drawings, like reference numerals designate corresponding parts throughout the several views.

FIG. 1 is a view generally illustrating the operation of the present system.

FIG. 2 is a sectional view of a wireless temperature sensor used in the system.

FIG. 3 is a sectional view of an optional embodiment of the invention illustrating a small antenna on the wireless temperature sensor.

### DETAILED DESCRIPTION OF THE INVENTION

The present wireless temperature sensor has been developed principally for use while cooking to permit remote monitoring of food temperature.

Consequently the description of the invention will be specifically with reference to such a food monitoring application although it will be readily apparent that many other uses are possible.

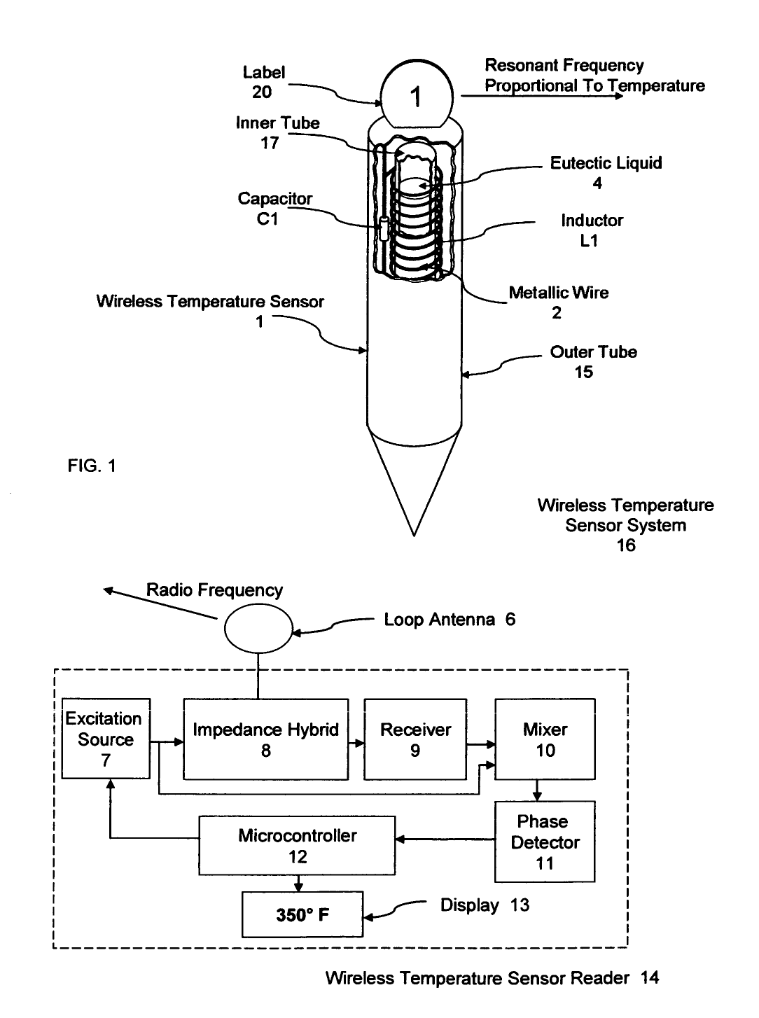

FIG. 1, shows a wireless temperature sensor system 16, in accordance with certain preferred embodiments of the present invention. A wireless temperature sensor 1, as shown, is preferably inserted into the food being cooked for continuously monitoring the internal temperature of the food. The wireless temperature sensor 1, comprises metallic wire 2, wrapped around a non-metallic inner tube 17, capable of withstanding repeated exposure to 500° F. for extended periods of time. The coiled wire 2, wrapped around the inner tube 17, creates an air core inductor L1. The ends of the wire 2, are connected to capacitor C1, to create an LC “tank” circuit. The inner tube 17, is filled with a eutectic liquid 4, such as Mercury or Galinstan, which exhibits the properties of being magnetic. As the temperature of the sensor 1, changes, the volume of the liquid 4, changes causing an increase in inductance and a corresponding decrease in resonant frequency of the LC “tank” circuit. Thus as will be appreciated, the resonant frequency of the sensor 1, is proportional to temperature that can be detected by a loop antenna. The remote temperature sensor reader 14, uses a swept sinusoidal excitation source 7, which drives a loop antenna 6, to transmit a signal, that inductively couples to the remote sensor 1. An impedance hybrid circuit 8, couples the loop antenna 6, for both transmitting and receiving. A receiver 9, receives the signal from the loop antenna 6. A mixer 10, mixes the signal down to baseband by a feedforward local oscillator signal synchronized with the transmitter excitation source. The mixer out is filtered and utilizes a phase detector 11, to sense resonant frequency. A micro-controller 12, synchronizes the phase detector to the transmit source to compute resonance and a display 13, displays the corresponding temperature.

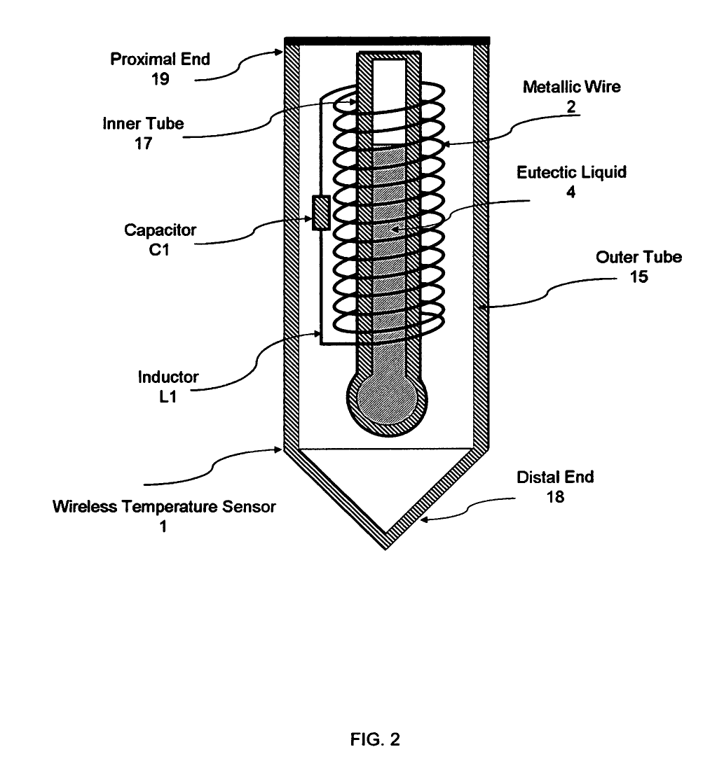

FIG. 2, shows a section view of a wireless temperature sensor 1, which is comprised of an inner tube 17 made of substantially rigid material which contains eutectic liquid 4. The inner tube 17, is wrapped with metallic wire 2 to create an air core inductor L1, and said wire is connected to capacitor C1, to create an LC “tank” circuit. The inner tube 17, is sealed so as to prevent escape of the eutectic liquid. The LC “tank” circuit is encased in an outer tube 15, made of substantially rigid non-metallic material. The outer tube 15, includes a distal end including a pointed end 18 and a proximal end 19. Proximal end 19, is sealed with high temperature material.

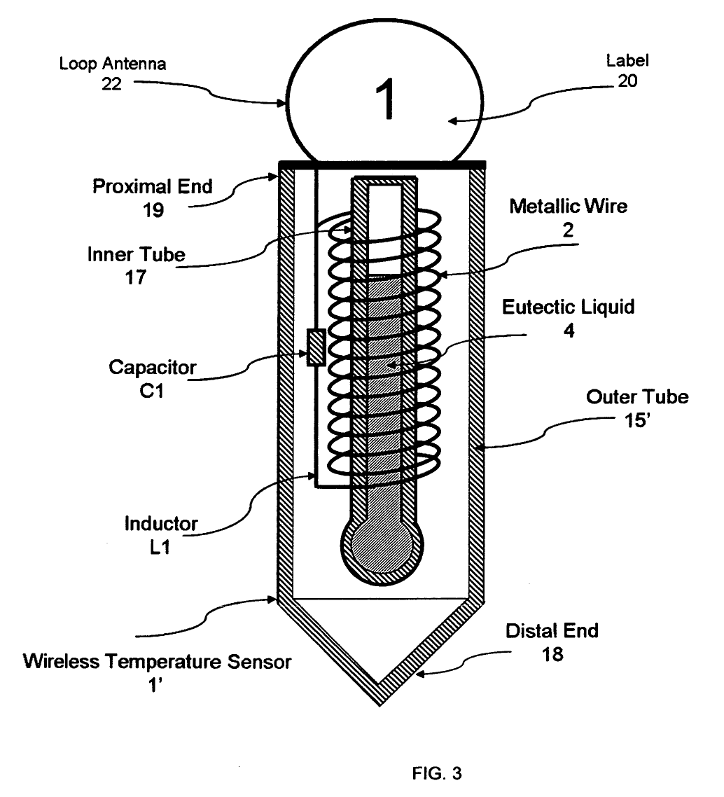

FIG. 3, shows a section view of an optional embodiment of the present invention. Sensor 1′, comprises an inner tube 17 made of nonmetallic substantially rigid material which contains eutectic liquid 4. The inner tube 17, is wrapped with wire to create an air core inductor L1, and said wire is connected to capacitor C1, to create an LC “tank” circuit. The inner tube 17, is sealed so as to prevent escape of the eutectic liquid. The LC “tank” circuit is encased in an outer tube 15′, made of substantially rigid metallic material such as stainless steel. The outer tube 15′, includes a distal end including a pointed end 18 and a proximal end 19. A label 20, affixed to proximal end 19, can be used to display identifying marks to differentiate individual sensors when used in conjunction with multiple sensors. Preferably, pointed end, at distal end 18, of sensor 1′, is inserted into a food item for temperature monitoring. Wire 2, is connected to the LC “tank” circuit through proximal end 19 which is sealed. Wire 2 is configured as a loop antenna 22, to allow communication between the LC “tank” circuit and the loop antenna.

The wireless temperature device and system that has been described are especially advantageous for use in the present contemplated monitoring function. However, the invention is more directly concerned with the provision of a system for remotely sensing the variations in the physical conditions of particular environments. In particular, the system provides a highly useful method for remotely sensing temperature changes. The capability of linking inductance type devices is a significant factor in that it permits the inserting of temperature probes in a food item and, nevertheless, assures remote sensing of temperature without a direct mechanical connection between the temperature sensor and the temperature sensor reader. Further, as has been noted, the beneficial results are achievable in a relatively simple and inexpensive device which is highly reliable over long periods of use.

Obviously many modifications and variations of the present invention are possible in the light of the above teachings. It is therefore to be understood that within the scope of the appended claims the invention may be practiced otherwise than as specifically described.

What is claimed is:

1. A method for wirelessly sensing and transmitting environmental temperature conditions comprising:
disposing a signal-receiving temperature sensor in said environment,
radiatively transmitting an electro-magnetic signal to said sensor,
varying said transmitted signal frequency to establish resonant frequency of said transducer,
utilizing said resonant frequency of said sensor to determine temperature of said environment,
whereby said temperature information is obtainable at a remote location by transmitting said signal to said sensor and receiving its condition-responsive resonant frequency.

2. The method of claim 1 wherein said resonant frequency of said sensor varies with inductance and temperature.

3. Implantable sensor apparatus for sensing environmental temperature conditions comprising:
inductive sensor means for sensing temperature conditions and producing a resonant frequency,
means for varying inductance based on temperature conditions,
means for varying resonant frequency based on inductance.

4. The apparatus of claim 3, further comprising an LC tank circuit of coiled wire, wrapped around a tube filled with a eutectic liquid.
